(19) United States
(12) Patent Application Publication
(10) Pub. No.: US 2026/0029987 A1
(43) Pub. Date: Jan. 29, 2026

(54) ELECTRONIC APPARATUS FOR CONTROLLING OBJECT INCLUDED IN SCREEN BASED ON USER VOICE AND CONTROLLING METHOD

(71) Applicant: SAMSUNG ELECTRONICS CO., LTD., Suwon-si (KR)

(72) Inventors: Jongin LEE, Suwon-si (KR); Sehyun KIM, Suwon-si (KR); Donguk KIM, Suwon-s (KR); Yeonwoo KIM, Suwon-si (KR); Donghwa JEONG, Suwon-si (KR); Minhyo JUNG, Suwon-si (KR)

(73) Assignee: SAMSUNG ELECTRONICS CO., LTD., Suwon-si (KR)

(21) Appl. No.: 19/240,975

(22) Filed: Jun. 17, 2025

Related U.S. Application Data
(63) Continuation of application No. PCT/KR2025/005913, filed on Apr. 30, 2025.

(30) Foreign Application Priority Data
Jul. 29, 2024 (KR) 10-2024-0100189

(51) Int. Cl. G06F 3/16; G06F 3/0488; G06V 10/74; G06V 20/62; G10L 15/22

(52) U.S. Cl. CPC G06F 3/167; G06F 3/0488; G06V 10/74; G06V 20/63; G10L 15/22; G10L 2015/223

(57) ABSTRACT

Provided is an electronic apparatus including: a microphone; memory storing instructions; and a processor configured to execute the instructions, wherein the instructions, when executed by the processor, cause the electronic apparatus to: based on receiving a user voice through the microphone while a screen including a plurality of first images is being output, obtain text corresponding to the user voice; identify a second image corresponding to the obtained text from among information about at least one text and an image corresponding to the at least one text, wherein the information about the at least one text and the image corresponding to the at least one text are stored in the memory; and based on the user voice and a captured image of the screen, control an object in an area of the screen corresponding to the identified second image.

### CROSS-REFERENCE TO RELATED APPLICATIONS

This application is a by-pass continuation of International Application No. PCT/KR2025/005913, filed on Apr. 30, 2025, which is based on and claims priority to Korean Patent Application No. 10-2024-0100189, filed in the Korean Intellectual Property Office on Jul. 29, 2024, the disclosures of which are incorporated by reference herein in their entireties.

### 1. FIELD

The present disclosure relates to an electronic apparatus and a controlling method thereof, and more particularly to an electronic apparatus that controls an object included in a screen based on a user voice and a controlling method thereof.

### 2. DESCRIPTION OF RELATED ART

With the development of multimedia technology, various streaming services are being provided to consumers. For example, recently, various streaming services that provide content through the Internet have been provided.

However, streaming services are often installed and provided in the form of an application on an electronic apparatus. In other words, the manufacturer of the electronic apparatus and the provider of the streaming service are different and thus, there is a limitation in that a user needs to control the application only with the input method supported by the application.

In particular, the recent development of electronic apparatuses with various form factors, such as head-mounted display (HMD) devices, has made it difficult to control applications related to streaming services.

### SUMMARY

The exemplary embodiments of the present disclosure may be diversely modified. Accordingly, specific exemplary embodiments are illustrated in the drawings and are described in detail in the detailed description. However, it is to be understood that the present disclosure is not limited to a specific exemplary embodiment, but includes all modifications, equivalents, and substitutions without departing from the scope and spirit of the present disclosure. Also, well-known functions or constructions are not described in detail since they would obscure the disclosure with unnecessary detail.

According to an aspect of the disclosure, an electronic apparatus includes: a microphone; memory storing one or more instructions; and one or more processors configured to individually or collectively execute the one or more instructions, wherein one or more instructions, when individually or collectively executed by the one or more processors, cause the electronic apparatus to: based on receiving a user voice through the microphone while a screen including a plurality of first images is being output, obtain text corresponding to the user voice; identify a second image corresponding to the obtained text from among information about at least one text and an image corresponding to the at least one text, wherein the information about the at least one text and the image corresponding to the at least one text are stored in the memory; and based on the user voice and a captured image of the screen, control an object in an area of the screen corresponding to the identified second image.

The electronic apparatus may further include: a communication interface; and a display, wherein the one or more instructions, when individually or collectively executed by the one or more processors, further cause the electronic apparatus to: control the display to output the screen based on a plurality of second images received from a server through the communication interface; and obtain information about each of a plurality of texts obtained from the plurality of second images and information about each second image, among the plurality of second images, corresponding to each of the plurality of texts.

The one or more instructions, when individually or collectively executed by the one or more processors, may further cause the electronic apparatus to obtain, as the information about each second image corresponding to each of the plurality of texts, a version of each second image corresponding to each of the plurality of texts having a changed resolution.

The one or more instructions, when individually or collectively executed by the one or more processors, may further cause the electronic apparatus to obtain, a compressed version of each resolution adjusted second image as information about each second image corresponding to each of the plurality of texts.

The one or more instructions, when individually or collectively executed by the one or more processors, may further cause the electronic apparatus to: identify one or more texts corresponding to each of the plurality of second images among the plurality of texts; identify at least one candidate text among the one or more texts corresponding to each of the plurality of second images; and obtain information about the one or more texts corresponding to each of the plurality of second images, the at least one candidate text, and each second image corresponding to each of the plurality of texts.

The electronic apparatus may further include: a communication interface; and a display, wherein the one or more instructions, when individually or collectively executed by the one or more processors, further cause the electronic apparatus to: receive the screen from a server through the communication interface; control the display to output the screen; and obtain information about at least one text obtained from the captured image and at least one first image corresponding to each of the at least one text.

The one or more instructions, when individually or collectively executed by the one or more processors, may further cause the electronic apparatus to control the object based on a command input method supported by an application corresponding to the screen.

The one or more instructions, when individually or collectively executed by the one or more processors, may further cause the electronic apparatus to, based on the command input method including a touch input method, control the object based on a command corresponding to touching a point in an area corresponding to the identified second image.

The one or more instructions, when individually or collectively executed by the one or more processors, may further cause the electronic apparatus to, based on the command input method not including a touch input method, control the object based on at least one first command for moving a focus included in the captured image to an area corresponding to the identified second image and a second image for executing the object after the at least one first command.

The one or more instructions, when individually or collectively executed by the one or more processors, may further cause the electronic apparatus to: move the focus; and identify a current location of the focus by comparing the captured image and another captured image corresponding to a screen after the focus is moved.

According to an aspect of the disclosure, a method of controlling an electronic apparatus includes: based on receiving a user voice through a microphone of the electronic apparatus while a screen including a plurality of first images is being output, obtaining text corresponding to the user voice; identifying a second image corresponding to the obtained text from among information about at least one text stored in the electronic apparatus and an image corresponding to the at least one text; and controlling an object in an area of the screen corresponding to the identified second image based on a captured image of the screen and the user voice.

The method may further include: outputting the screen based on a plurality of second images received from a server; and obtaining information about each of a plurality of texts obtained from the plurality of second images and information about each second image, among the plurality of second images, corresponding to each of the plurality of texts.

The obtaining information about each of the plurality of texts and each second image, among the plurality of second images, corresponding to each of the plurality of texts may include obtaining, as the information about each second image corresponding to each of the plurality of texts, a version of each second image corresponding to each of the plurality of texts having a changed resolution.

The obtaining information about each of the plurality of texts and each second image corresponding to each of the plurality of texts may further include obtaining a compressed version of each resolution adjusted second image as information about each second image corresponding to each of the plurality of texts.

The obtaining information about each of the plurality of texts and each second image corresponding to each of the plurality of texts may include: identifying one or more texts corresponding to each of the plurality of second images among the plurality of texts; identifying at least one candidate text among the one or more texts corresponding to each of the plurality of second images; and obtaining information about the one or more texts corresponding to each of the plurality of second images, the at least one candidate text, and each second image corresponding to each of the plurality of texts.

According to an aspect of the disclosure, a non-transitory computer readable medium has instructions stored therein, which when executed by at least one processor cause the at least one processor to execute a method of controlling an electronic apparatus, the method including: based on receiving a user voice through a microphone of the electronic apparatus while a screen including a plurality of first images is being output, obtaining text corresponding to the user voice; identifying a second image corresponding to the obtained text from among information about at least one text stored in the electronic apparatus and an image corresponding to the at least one text; and controlling an object in an area of the screen corresponding to the identified second image based on a captured image of the screen and the user voice.

With regard to the non-transitory computer readable medium, the method may further include: outputting the screen based on a plurality of second images received from a server; and obtaining information about each of a plurality of texts obtained from the plurality of second images and information about each second image, among the plurality of second images, corresponding to each of the plurality of texts.

With regard to the non-transitory computer readable medium, the obtaining information about each of the plurality of texts and each second image, among the plurality of second images, corresponding to each of the plurality of texts may include obtaining, as the information about each second image corresponding to each of the plurality of texts, a version of each second image corresponding to each of the plurality of texts having a changed resolution.

With regard to the non-transitory computer readable medium, the obtaining information about each of the plurality of texts and each second image corresponding to each of the plurality of texts may further include obtaining a compressed version of each resolution adjusted second image as information about each second image corresponding to each of the plurality of texts.

With regard to the non-transitory computer readable medium, wherein the obtaining information about each of the plurality of texts and each second image corresponding to each of the plurality of texts may include: identifying one or more texts corresponding to each of the plurality of second images among the plurality of texts; identifying at least one candidate text among the one or more texts corresponding to each of the plurality of second images; and obtaining information about the one or more texts corresponding to each of the plurality of second images, the at least one candidate text, and each second image corresponding to each of the plurality of texts.

### BRIEF DESCRIPTION OF THE DRAWINGS

The above and other aspects and features of certain embodiments of the present disclosure will be more apparent from the following description taken in conjunction with the accompanying drawings, in which:

FIGS. 1A, 1, and 1C are views provided to explain a difficulty in controlling a screen to help understanding of the present disclosure;

FIG. 2 is a block diagram illustrating a configuration of an electronic apparatus according one or more embodiments;

FIG. 3 is a block diagram illustrating a detailed configuration of an electronic apparatus according to an embodiment;

FIG. 4 is a block diagram illustrating a configuration of an electronic system according to an embodiment;

FIG. 5 is a flowchart provided to explain an operation of storing mapping information according to an embodiment;

FIG. 6 is a flowchart provided to explain an operation of processing an object corresponding to a user voice based on mapping information according to an embodiment;

FIG. 7 is a view provided to explain an operation of identifying a location of a focus according to an embodiment;

FIG. 8 is a view provided to explain an operation of identifying information about a poster in advance before a user voice is received according to an embodiment; and

FIG. 9 is a flowchart provided to explain a control method of an electronic apparatus according to an embodiment.

### DETAILED DESCRIPTION

The present disclosure provides an electronic apparatus for increasing the speed and accuracy of controlling an object included in a screen through a user voice and a control method thereof.

The various embodiments provided in this disclosure, and the terms used herein, are not intended to limit the technical features of this disclosure to specific embodiments, but should be understood to include various modifications, equivalents or alternatives of the corresponding embodiments.

With respect to the description of the drawings, similar components may be denoted by similar reference numerals.

The singular form of a noun corresponding to an item may include one item or a plurality of items, unless the relevant context clearly indicates otherwise.

In this disclosure, “A or B”, “at least one of A and B”, “at least one of A or B”, “A, B or C”, “at least one of A, B and C”, and “at least one of A, B, or C” may each include any one of the items listed together in the corresponding phrase, or any possible combination thereof.

Terms “first”, “second”, “1^{st},” or “2^{nd},” may be used simply to distinguish the corresponding component from other corresponding components, and may limit the corresponding components in other aspects (e.g., importance or order).

When it is mentioned that one (e.g., first) component is “coupled” or “connected” to another (e.g., second) component, with or without the terms “functionally” or “communicatively”, it means that the component can be connected to another component directly (e.g., wired), wirelessly, or through a third component.

Terms such as “have” or “include” are intended to designate the presence of features, numbers, steps, operations, components, parts, or a combination thereof described in this disclosure, but are not intended to exclude the presence or addition of one or more other features, numbers, steps, operations, components, parts, or a combination thereof in advance.

When a component is said to be “connected,” “coupled,” “supported,” or “in contact” with another component, this means not only when the components are directly connected, coupled, supported, or in contact, but also when they are indirectly connected, coupled, supported, or in contact through a third component.

When a component is said to be located “on” another component, this includes not only a case where a component is in contact with another component, but also a case where another component exists between the two components.

The term “and/or” includes a combination of a plurality of related elements described herein or any element of a plurality of related elements described herein.

Hereinafter, the operation principle of the present disclosure and embodiments thereof will be described with reference to the accompanying drawings.

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

The various actions, acts, blocks, steps, or the like in the flow diagrams may be performed in the order presented, in a different order, or simultaneously. Further, in one or more embodiments, some of the actions, acts, blocks, steps, or the like may be omitted, added, modified, skipped, or the like without departing from the scope of the disclosure.

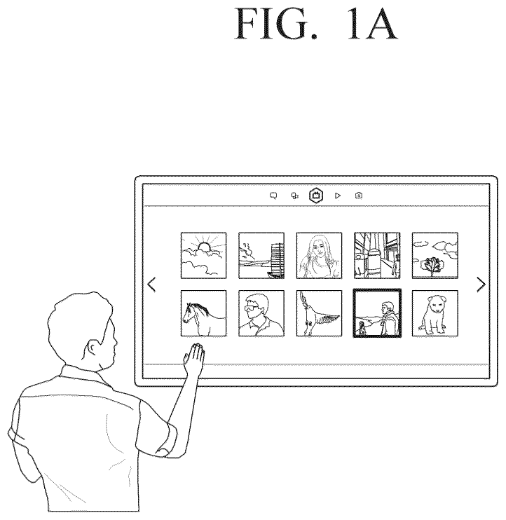

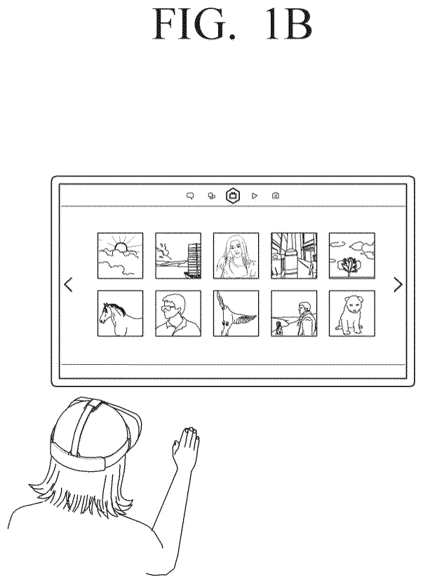

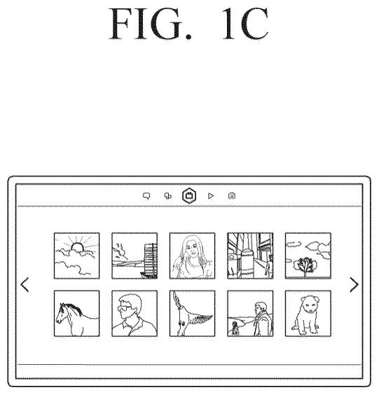

FIGS. 1A, 1i, and 1C are views provided to explain a difficulty in controlling a screen to help understanding of the present disclosure.

Recently, with the development of electronic apparatuses in various form factors, control methods using gesture recognition, eye tracking, or AI assistance based on voice recognition are being provided. In other words, control methods that do not use the existing remote controller are being developed. With regard to voice recognition, linguistic understanding is a technology that recognizes and applies/processes human language/characters, and includes natural language processing, machine translation, dialogue systems, questions and answers, and voice recognition/synthesis, etc.

However, as shown in FIGS. 1A and 1B, it is challenging for an electronic apparatus to accurately recognize user gestures from a distance of 3 to 4 meters and to control a detailed user interface (UI) based on such user gestures. For example, various issues may arise, such as poor recognition performance at a long distance or in low light, lack of comfortable control operations, and identification of gestures of multiple people. In addition, eye tracking is more difficult than gesture recognition, so methods using voice recognition are being actively researched.

Voice has the advantage of being relatively unrestricted in environments such as long distances and low light, has high recognition accuracy, and there are little to no limitations on the information that can be expressed linguistically. By contrast, the method of expressing spatial (visual) information may be very limited, such as directional information (e.g., up/down/left/right).

Most UIs provided by electronic apparatuses are optimized for 4-way remote controls and need to be optimized for voice. However, since most streaming services are provided by third parties, it is difficult to change the UIs, and the existing methods of using voice have problems with delay and low accuracy.

For example, when the manufacturer of the electronic apparatus and the provider of the streaming service are different, screen capture and text recognition may be performed in the process of controlling the application providing the streaming service by voice, as shown FIG. 1C, and this process may result in reduced accuracy and delay.

For example, when a user voice is received, the electronic apparatus may capture an image of a screen, perform an optical character reader (OCR) on the captured image to identify text included in the screen, and identify the location of the text corresponding to the user voice to control an object corresponding to the text corresponding to the user voice. However, such a process is performed after the user voice is received, which may result in delay. Further, when the screen such as FIG. 1C has a resolution of, for example, 1280×720, each of a plurality of images included in the screen has a resolution of only approximately 180×60, so errors may occur in the process of identifying text from each of the plurality of images. Therefore, it is necessary to reduce delay time and errors.

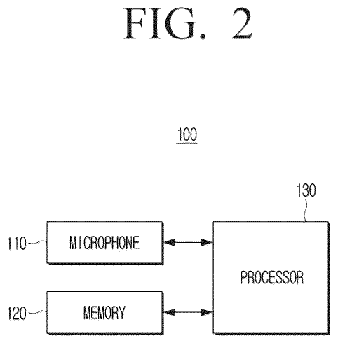

FIG. 2 is a block diagram illustrating a configuration of an electronic apparatus 100 according to an embodiment.

The electronic apparatus 100 may be an apparatus for controlling the electronic apparatus 100 based on a user voice. In particular, the electronic apparatus 100 may be an apparatus that controls an object displayed on a screen based on a user voice, and may be an apparatus equipped with a display, such as a TV, a desktop PC, a laptop, a smartphone, a tablet PC, smart glasses, a smart watch, an HMD, etc., which controls an object displayed on the screen based on a user voice. Here, the screen may be a screen of a 3rd party application.

However, the electronic apparatus 100 is not limited thereto, and may be an apparatus that provides screen information to an external display device and controls an object included in the screen displayed on the external display device based on a user voice. For example, the electronic apparatus 100 may be a computer main body, a set-top box (STB), or the like.

Referring to FIG. 2, the electronic apparatus 100 may include a microphone 110, memory 120, and a processor 130.

The microphone 110 may be configured to receive sound input and convert it into an audio signal. The microphone 110 may be electrically coupled to the processor 130, and may receive sound under the control of the processor 130.

For example, the microphone 110 may receive a user voice in analog form, digitize it, and provide the digitized signal to processor 130.

The microphone 110 may be integrally formed with the electronic apparatus 100 as being integrated in the top, front, or side direction of the electronic apparatus 100. Alternatively, the microphone 110 may be provided on a remote control or the like that is separate from the electronic apparatus 100. In this case, the remote control may receive sound via the microphone 110 and provide the received sound to the electronic apparatus 100.

The microphone 190 may include various components such as a microphone that collects analog sound, an amplification circuit that amplifies the collected sound, an A/D conversion circuit that samples the amplified sound and converts it into a digital signal, a filter circuit that removes noise components from the converted digital signal, etc.

The microphone 110 may be implemented in the form of a sound sensor, and any configuration may be used as long as it is configured to collect sound.

The memory 120 may refer to hardware that stores information such as data in electrical or magnetic form for access by the processor 130 or the like. To this end, the memory 120 may be implemented as at least one of non-volatile memory, volatile memory, flash memory, hard disk drive (HDD) or solid state drive (SSD), RAM, ROM, etc.

The memory 120 may store at least one instruction required for the operation of the electronic apparatus 100 or the processor 130. Here, the instruction may be a code unit that instructs the operation of the electronic apparatus 100 or the processor 130, and may be written in a machine language that can be understood by a computer. Alternatively, the memory 120 may store a plurality of instructions for performing specific tasks of the electronic apparatus 100 or the processor 130 as an instruction set.

The memory 120 may store data which is information in bits or bytes capable of representing characters, numbers, images, and the like. For example, the memory 120 may store mapping information. Here, the mapping information may be information that maps information about at least one text and an image corresponding to the at least one text.

The memory 120 may be accessed by the processor 130, and reading/writing/modifying/deleting/updating of instructions, instruction sets, or data may be performed by the processor 130.

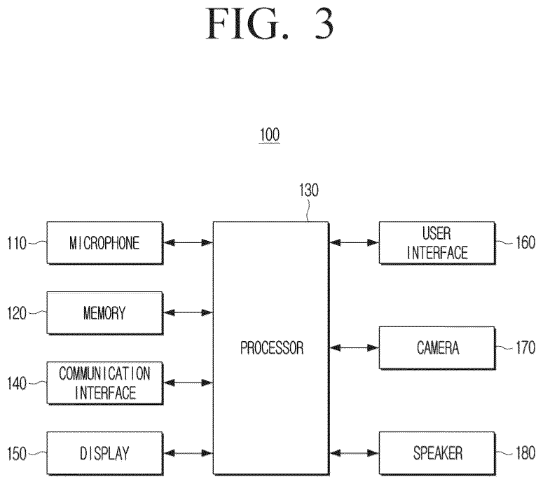

The processor 130 may control the overall operation of the electronic apparatus 100. Specifically, the processor 130 may be connected to each component of the electronic apparatus 100 to control the overall operation of the electronic apparatus 100. For example, the processor 130 may be connected to components such as the microphone 110, the memory 120, a communication interface 140 (see, e.g., FIG. 3), and the like to control the operation of the electronic apparatus 100.

The processor 130 may one or more processors, and my further include one or more of a central processing unit (CPU), a graphics processing unit (GPU), an accelerated processing unit (APU), a many integrated core (MIC), a neural processing unit (NPU), a hardware accelerator, or a machine learning accelerator. The at least one processor 130 may control one or any combination of other components of the electronic apparatus 100, and may perform operations related to communication or data processing. The at least one processor 130 may individually or collectively execute one or more programs or instructions stored in the memory 120. For example, the at least one processor 130 may perform a method according to an embodiment of the present disclosure by executing one or more instructions stored in the memory 120.

In a case where the method according to an embodiment of the disclosure includes a plurality of operations, the plurality of operations may be performed by one processor or by a plurality of processors. For example, in a case where a first operation, a second operation, and a third operation are performed by the method according to an embodiment, all of the first operation, the second operation, and the third operation may be performed by a first processor, or the first operation and the second operation may be performed by the first processor (e.g., a general-purpose processor) and the third operation may be performed by a second processor (e.g., an artificial intelligence-dedicated processor).

The at least one processor 130 may be implemented as a single-core processor including one core, or may be implemented as one or more multi-core processors including a plurality of cores (e.g., homogeneous multiple cores or heterogeneous multiple cores). In a case where the at least one processor is implemented as multi-core processors, each of the plurality of cores included in the multi-core processors may include a processor internal memory such as a cache memory or an on-chip memory, and a common cache shared by the plurality of cores may be included in the multi-core processors. In addition, each of the plurality of cores (or some of the plurality of cores) included in the multi-core processors may independently read and execute program instructions for implementing the method according to an embodiment, or all (or some) of the plurality of cores may be linked to each other to read and execute program instructions for implementing the method according to an embodiment.

In a case where the method according to an embodiment includes a plurality of operations, the plurality of operations may be performed by one of the plurality of cores included in the multi-core processors, or may be performed by the plurality of cores. For example, in a case where a first operation, a second operation, and a third operation are performed by the method according to an embodiment, all of the first operation, the second operation, and the third operation may be performed by a first core included in the multi-core processors, or the first operation and the second operation may be performed by the first core included in the multi-core processors, and the third operation may be performed by a second core included in the multi-core processors.

In embodiments of the disclosure, the at least one processor 130 may refer to a system on a chip (SoC) in which one or more processors and other electronic components are integrated, a single-core processor, multi-core processors, or a core included in the single-core processor or the multi-core processors. Here, the core may be implemented as CPU, GPU, APU, MIC, NPU, hardware accelerator, machine learning accelerator, or the like, but the embodiments of the disclosure are not limited thereto. However, hereinafter, for convenience of explanation, the operation of the electronic apparatus 100 will be described with the expression of the processor 130.

The processor 130 may output a screen including a plurality of first images via the electronic apparatus 100 or via an external display device. When outputting the screen via an external display device, the processor 130 may provide screen information to the external display device. Hereinafter, for convenience of explanation, it is described that the electronic apparatus 100 includes a display, and the screen is output via the display.

When a user voice is received via the microphone 110 while the screen including the plurality of first images is being output, the processor 130 may obtain a text corresponding to the user voice.

The processor 130 may identify a second image corresponding to the obtained text among information about at least one text and an image corresponding to the at least one text stored in the memory 120. The information about the at least one text and the image corresponding to the at least one text may be mapped and stored in the memory 120 as mapping information.

For example, the mapping information may be information in which information about at least one text obtained from the screen that is being output before a user voice is received and the image corresponding to the at least one text are mapped.

For instance, when an application is executed, the processor 130 may receive a plurality of second images from a server corresponding to the executed application and output a screen including a plurality of first images based on each of the plurality of second images. For example, each of the plurality of second images may have a resolution of 1280×720, and each of the plurality of first images may have a resolution of 180×60.

The processor 130 may obtain a plurality of texts from each of the plurality of second images, and may obtain information about each of the plurality of texts and the second image corresponding to each of the plurality of texts. The processor 130 may store the obtained information in the memory 120. For example, the processor 130 may identify a title 1 representing a second image 1 from among the plurality of second images, map information about the title 1 and the second image 1 to obtain mapping information, and store the obtained information in the memory 120. As such, the processor 130 may obtain mapping information for all of the plurality of second images, and store the obtained information in the memory 120. In other words, since the processor 130 obtains mapping information based on the plurality of second images that are originals of the plurality of first images and have high resolution, rather than the plurality of first images included in the screen, text identification performance can be improved.

However, the mapping information is not limited thereto, and may further include information obtained from a previous screen of the screen that is being output.

The processor 130 may change the resolution of the plurality of second images based on the resolution of each of the plurality of first images, obtain each of the plurality of second images with changed resolution as information about the second image corresponding to each of the plurality of texts, and store the obtained information in the memory 120. In other words, in the text identification process, the second image with the original resolution is used, but after the text identification is completed, the second image with the reduced resolution may be stored in the memory 120 to save storage space.

However, the processor 130 is not limited thereto, and the processor 130 may also obtain mapping information by mapping information about each of the plurality of texts and the second image corresponding to each of the plurality of texts without changing the resolution, and store the obtained information in the memory 120.

The processor 130 may further obtain compressed versions of each of the plurality of resized second images, where the compressed versions are compressed based on an encoder included in the electronic apparatus 100 and whose resolutions were previously adjusted, as information about the second image corresponding to each of the plurality of texts, and store the obtained information in the memory 120. In other words, a storage space can be saved further through downscaling and compression.

The processor 130 may identify a text corresponding to each of the plurality of second images and at least one candidate text among a plurality of texts from each of the plurality of second images, obtain information about the text corresponding to each of the plurality of second images, the at least one candidate text, and the second image corresponding to each of the plurality of texts, and store the obtained information in the memory 120.

In the embodiment described above, the processor 130 may further identify a candidate title 1 as well as the title 1 representing the second image 1 from among the plurality of second images. The processor 130 may map the title 1 and the candidate title 1 with information about the second image 1 to obtain mapping information, and may store the obtained information in the memory 120. Since an error may occur in the text identification process, candidate texts may be further stored and used in a subsequent process of identifying the location of the screen corresponding to the user voice.

In the above, it is assumed that the processor 130 may access images related to a third party application. However, the processor 130 is not limited thereto, and the processor 130 may not be able to access images related to a third party application.

For example, when an application is executed, the processor 130 may receive a screen from a server corresponding to the executed application, and output the received screen. In this case, the processor 130 may obtain information about at least one text in a captured image corresponding to the screen and the first image corresponding to each of the at least one text, and store the obtained information in the memory 120.

Once the second image is identified, the processor 130 may control an object included in an area corresponding to the identified second image in the captured image of the screen based on the user voice.

The processor 130 may control an object based on a command input method supported by the application corresponding to the screen.

For example, when the command input method includes a touch input method, the processor 130 may control an object based on a command to touch a point in an area corresponding to the identified second image.

Alternatively, when the command input method does not include a touch input method, the processor 130 may identify a focus in the captured image, and control an object based at least one first command to move the focus to an area corresponding to the identified second image and the second command for executing the object after the first command. Here, the processor 130 may move the focus, and identify the current location of the focus by comparing the captured image and another captured image corresponding to the screen after the focus is moved. However, the disclosure is not limited thereto, and the processor 130 may identify the location of the focus by analyzing the captured image itself.

FIG. 3 is a block diagram illustrating a detailed configuration of the electronic apparatus 100 according to an embodiment. The electronic apparatus 100 may include the microphone 110, the memory 120 and the processor 130. In addition, according to FIG. 3, the electronic apparatus 100 may further include a communication interface 140, a display 150, a user interface 160, a camera 170, and a speaker 180. The components shown in FIG. 3 that overlap with those shown in FIG. 2 will not be described in detail.

The communication interface 140 is configured to perform communication with various types of external devices according to various types of communication methods. For example, the electronic apparatus 100 may perform communication with a server via the communication interface 140.

The communication interface 140 may include a Wi-Fi module, a Bluetooth module, an infrared communication module, a wireless communication module, and the like. Here, each communication module may be implemented in the form of at least one hardware chip.

The Wi-Fi module and the Bluetooth module may perform communication using a Wi-Fi method and a Bluetooth method, respectively. When using a Wi-Fi module or a Bluetooth module, various connection information such as SSID and session keys are first transmitted and received, and various information can be transmitted and received after establishing communication connection using this. The infrared communication module performs communication according to an infrared Data Association (IrDA) communication technology which transmits data wirelessly over a short distance using infrared rays between optical light and millimeter waves.

The wireless communication module may include at least one communication chip that performs communication according to various wireless communication standards, such as Zigbee, 3rd Generation (3G), 3rd Generation Partnership Project (3GPP), Long Term Evolution (LTE), LTE advanced (LTE-A), 4th Generation (4G), 5th Generation (5G), etc. in addition to the above-described communication methods.

Alternatively, the communication interface 140 may include a wired communication interface such as HDMI, DP, Thunderbolt, USB, RGB, D-SUB, DVI, etc.

In addition, the communication interface 140 may include at least one of a Local Area Network (LAN) module, an Ethernet module or a wired communication module that performs communication using a pair cable, a coaxial cable or an optical fiber cable.

The display 150 may be configured to display an image, and may be implemented as various types of displays, such as liquid crystal displays (LCDs), organic light emitting diodes (OLEDs) displays, plasma display panels (PDPs), and the like. The display 150 may also include a driving circuit, a backlight unit, and the like, which may be implemented in the form of a-si TFTs, low temperature poly silicon (LTPS) TFTs, organic TFTs (OTFTs), and the like. The display 150 may be implemented as a touch screen combined with a touch sensor, a flexible display, a three-dimensional (3D) display, and the like.

The user interface 160 may be implemented as a button, a touch pad, a mouse, a keyboard, etc., or may be implemented as a touch screen that can also perform a display function and a manipulation input function. Here, the button may be a various types of buttons such as a mechanical button, a touch pad, a wheel, etc. formed in any arbitrary area such as front, side, back, etc.

The camera 170 may be configured to capture still images or moving images. The camera 170 may capture still images at a specific point in time, but may also capture still images continuously.

The camera 170 may photograph the front of the electronic apparatus 100 to capture the actual environment in front of the electronic apparatus 100. The processor 130 may identify areas of interest from the images captured through the camera 170.

The camera 170 may include a lens, a shutter, an aperture, a solid-state imaging device, an analog front end (AFE), and a timing generator (TG). The shutter controls the time when light reflected from a subject enters the camera 170, and the aperture controls the amount of light entering the lens by mechanically increasing or decreasing the size of the opening through which the light enters. When the light reflected from the subject is accumulated as a photoelectric charge, the solid-state imaging device outputs an image by the photoelectric charge as an electrical signal. The TG outputs a timing signal to read out the pixel data of the solid-state imaging device, and the AFE samples and digitizes the electrical signal output from the solid-state imaging device.

The speaker 180 may be configured to output not only various audio data processed by the processer 130 but also various notification sounds, voice messages, etc.

As described above, since the electronic apparatus 100 stores the mapping information from the screen in advance, the processing speed according to a user voice may be improved. Further, since the electronic apparatus 100 obtains the mapping information based on the original images of the images included in the screen, the accuracy may be improved, and the processing performance according to a user voice may be improved.

In the above, it is described that the application is an application provided by a third party, but the disclosure is not limited thereto. For example, the application may be an application provided by the manufacturer of the electronic apparatus 100. However, even if the application is provided by the manufacturer of the electronic apparatus 100, the above disclosure may be applied when it is not possible to input a command through voice recognition. In addition, the electronic apparatus 100 may be a display device such as a TV, and the above disclosure may be applied to control a screen received from an external device such as an STB.

Further, in the above, the hardware operation of the electronic apparatus 100 is described, but the above disclosure may be implemented as software. For example, the electronic apparatus 100 may execute a voice control application in the background. When a user voice is received while an application different from the voice control application is running, the voice control application may obtain a text corresponding to the user voice, identify a second image corresponding to the text among information about at least one text and an image corresponding to the at least one text stored in the electronic apparatus 100, and control an object included in an area corresponding to the second image identified in a captured image corresponding to the screen based on the user voice. For these operations, the voice control application may be granted more authority than a general application. For example, the voice control application may be excluded from memory refresh even though it runs in the background, and when a plurality of second images are received from a server 200 in response to the execution of the application, may be able to access the plurality of second images.

The above describes the operation in which the electronic apparatus 100 stores information about at least one text and an image corresponding to the at least one text as mapping information, but the present disclosure is not limited thereto. For example, when a plurality of second images are received from the server 200, the electronic apparatus 100 may obtain a plurality of fingerprints from each of the plurality of second images, map each of the plurality of fingerprints and information about the second image corresponding to each of the plurality of fingerprints, and store it as mapping information. In other words, the electronic apparatus 100 may identify an image using the fingerprint rather than the text corresponding to the image. Further, any method capable of identifying and specifying not only texts and fingerprints but also images may be applied. For example, the electronic apparatus 100 may obtain identification information about an image by using a neural network model that generates identification information from the image, and may map the identification information and the image and store it as mapping information

In the above, it is described that the electronic apparatus 100 obtains a text corresponding to a user voice from the user voice, but the electronic apparatus 100 is not limited thereto. For example, when the electronic apparatus 100 receives a user voice, the electronic apparatus 100 may transmit the user voice to a server and receive a text corresponding to the user voice from the server. Here, the server may include a speech to text (STT) server.

The function related to artificial intelligence according to the present disclosure may be operated through the processor and the memory 120.

The processor 130 may consist of one or more processors. In this case, one or more processors may be general-purpose processors such as CPU, AP, or Digital Signal Processor (DSP), dedicated graphics processors such as GPU or Vision Processing Unit (VPU), or dedicated artificial intelligence processors such as NPU.

One or more processors control input data to be processed according to predefined operation rules or artificial intelligence models stored in the memory 120. Alternatively, when one or more processors are dedicated artificial intelligence processors, the dedicated artificial intelligence processors may be designed with a hardware structure specialized for processing a specific artificial intelligence model. The predefined operation rules or artificial intelligence models are characterized by being created through training.

Here, ‘being created through training’ means that the basic artificial intelligence model is trained using a large number of learning data by a learning algorithm and thus, predefined operation rules or artificial intelligence are set to perform the desired characteristics (or purpose). Such training may be accomplished in the apparatus itself that performs artificial intelligence according to the present disclosure, or may be accomplished through a separate server and/or system. Examples of learning algorithms include, but are not limited to, supervised learning, unsupervised learning, semi-supervised learning, or reinforcement learning.

An artificial intelligence model may consist of a plurality of neural network layers. Each of the plurality of neural network layers has a plurality of weight values, and neural network calculation is performed through calculation between the calculation result of the previous layer and the plurality of weights. The plurality of weights of the plurality of neural network layers may be optimized by the learning results of the artificial intelligence model. For example, during the learning process, the plurality of weights may be updated so that loss or cost values obtained from the artificial intelligence model are reduced or minimized.

The artificial neural network may include a deep neural network (DNN), for example, Convolutional Neural Network (CNN), Deep Neural Network (DNN), Recurrent Neural Network (RNN), Restricted Boltzmann Machine (RBM), DBN (Deep Belief Network), BRDNN (Bidirectional Recurrent Deep Neural Network), Generative Adversarial Network (GAN), or Deep Q-Networks, etc., but is not limited thereto.

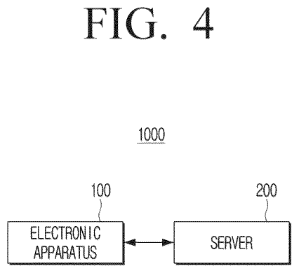

Hereinafter, the operation of the electronic apparatus 100 will be described in greater detail with reference to FIGS. 4 to 8. For convenience of explanation, individual embodiments are described in FIGS. 4 through 8. However, the individual embodiments of FIGS. 4 to 8 may be practiced in any combination.

FIG. 4 is a block diagram illustrating a configuration of an electronic system 1000 according to an embodiment. As shown in FIG. 4, the electronic system 1000 may include the electronic apparatus 100 and the server 200.

When the application is executed, the electronic apparatus 100 may receive a plurality of second images from the server 200 corresponding to the executed application and output a screen including a plurality of first images based on each of the plurality of second images.

Alternatively, when the application is executed, the electronic apparatus 100 may receive a screen from the server 200 corresponding to the executed application, and output the screen.

The server 200 may be a device that stores data related to the application. For example, the server 200 may be a device that stores a plurality of contents provided by the application and a plurality of thumbnails (or images such as posters) corresponding to each of the plurality of content, and may be a desktop PC, laptop, smartphone, tablet PC, or the like. However, the server 200 is not limited thereto, and may be any device capable of storing data related to the application.

When the application is executed in the electronic apparatus 100, the server 200 may receive an image request signal from the electronic apparatus 100 in response to the execution of the application, and may provide a plurality of second images to the electronic apparatus 100 or provide screen information corresponding to the application to the electronic apparatus 100.

However, the present disclosure is not limited thereto, and there may be a plurality of servers 200 for each application. The server 200 may also be a device that reviews a text received from the electronic apparatus 100. For example, the server 200 may provide a plurality of second images to the electronic apparatus 100 in response to a request from the electronic apparatus 100. The electronic apparatus 100 may identify a plurality of texts from each of the plurality of second images, and provide the plurality of texts to the server 200. The server 200 may correct the plurality of texts based on the stored data, and provide the corrected plurality of texts to the electronic apparatus 100. The electronic apparatus 100 may map each of the corrected plurality of texts and information about the second image corresponding to each of the corrected plurality of texts to obtain mapping information, and store the obtained information in the memory 120. For example, the server 200 may obtain the second image 1 and title AAA of the second image 1, and store the obtained information in the memory 120. In this case, when AAA′ is received as one of the plurality of texts from the electronic apparatus 100, the server 200 may correct AAA′ to AAA and provide it to the electronic apparatus 100. Such an operation may reduce errors in the text identification process.

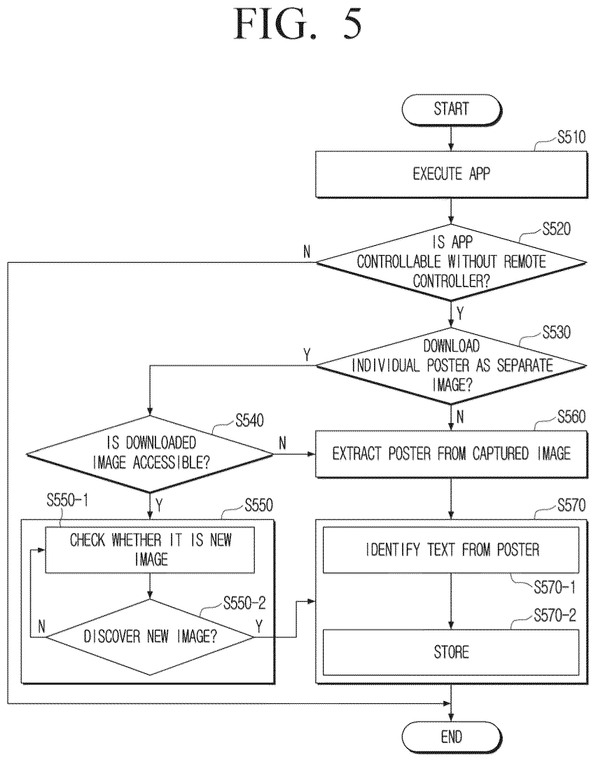

FIG. 5 is a flowchart provided to explain an operation of storing mapping information according to an embodiment. Since an actual application includes a plurality of posters (images such as thumbnails) on the screen, the term poster is used interchangeably with the term image in FIG. 5.

First, when an application is executed (S510), the processor 130 may identify whether the executed application is an application that can be controlled without a remote controller (S520).

When the executed application is an application that cannot be controlled without a remote controller, the processor 130 may terminate the executed, and when the executed application is an application that can be controlled without a remote controller, the processor 130 may identify whether individual posters are downloaded as separate images (S530). For example, when an application is executed, the processor 130 may receive a plurality of second images from a server corresponding to the application. Here, the second images may be a poster.

When the individual posters are not downloaded as separate images, the processor 130 may extract posters from the captured image (S560). For example, upon receiving pixel information about the screen itself, including a plurality of first images, from the server, the processor 130 may output the screen and extract posters from the captured image corresponding to the screen. Alternatively, when the individual posters are downloaded as separate images but are not accessible, the processor 130 may output the screen including the individual posters and extract posters from the captured image corresponding to the screen.

The processor 130 may identify a text in a poster (S570-1), map the text with the poster and obtain it as mapping information, and store the obtained information (S570-2).

Alternatively, when the individual posters are downloaded as separate images, the processor 130 may identify whether the downloaded images are accessible (S540), when the downloaded images are accessible, determine whether the downloaded images are new images (S550-1), and when a new image is discovered (S550-2), perform operation S570. Here, the operation of checking whether it is a new image may be performed by identifying whether there is an added image compared to the existing images.

However, the present disclosure is not limited thereto, and the processor 130 may extract posters from the captured image at a preset time interval. Alternatively, the processor 130 may extract posters from the captured image each time a screen provided by the application is switched.

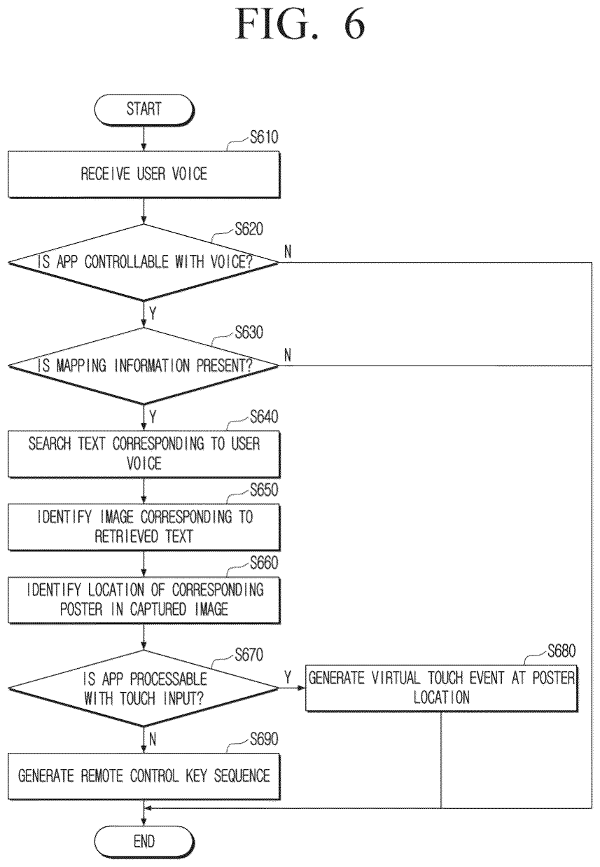

Although FIG. 5 describes that mapping and storing only posters and texts, the present disclosure is not limited thereto. For example, the processor 130 may identify the location of each poster before a user voice is received. For example, the processor 130 may identify the location of each poster in the captured image after operation S570-2 is completed. In this case, when a user voice is received, the processor 130 may obtain a text corresponding to the user voice, identify a poster mapped to the text corresponding to the user voice from the mapping information, and obtain the location of the identified poster from the stored information. In such an operation, the operation of comparing the captured image and the poster to identify the location of the poster is performed before receiving the user voice rather than after receiving the user voice, so the processing time after receiving the user voice can be reduced. This effect will be further described with reference to FIG. 6.

FIG. 6 is a flowchart provided to explain an operation of processing an object corresponding to a user voice based on mapping information according to an embodiment.

First, the processor 130 may receive a user voice (S610), and identify whether the executed application is an application that can be controlled with a voice (S620).

When the executed application is an application that cannot be controlled with a voice, the processor 130 may terminate the executed application, and when the executed application is an application that can be controlled with a voice, the processor 130 may identify whether there is mapping information (S630).

When the mapping information is not stored in the memory 120, the processor 130 may terminate the application, and when the mapping information is stored in the memory 120, the processor 130 may search a text corresponding to the user voice (S640), and identify an image corresponding to the retrieved text (S650). For example, when mapping information such as (AAA, image A), (ABA, image B), and (CCC, image C) is stored in the memory 120 and a text corresponding to the user voice is ABA, the processor 130 may finally identify image B based on (ABA, B image) among the mapping information.

The processor 130 may identify the location of the poster corresponding to the identified image in the captured image (S660). In the embodiment described above, the processor 130 may identify the location of the poster corresponding to image B in the captured image.

The processor 130 may identify whether the executed application is an application capable of processing a touch input (S670), and if it is capable of processing a touch input, generate a virtual touch event at the poster location (S680), and if it is not capable of processing a touch input, generate a remote control key sequence (S690).

The processor 130 may identify the location of the poster before the user voice is received, as described in FIG. 5. In this case, the processor 130 may identify location information corresponding to the retrieved text instead of performing operations S650, S660. For example, the memory 120 may store mapping information such as (AAA, image A, output o, (x1, y1)), (ABA, image B, output o, (x2, y2)), and (CCC, image C, output x, (, )). Here, the mapping information may further store whether to output or not and the output coordinate values. In the case of image C, it is not being output and thus, the coordinate values cannot be obtained. When the text corresponding to the user voice is ABA, the processor 130 may finally identify the output location (x2, y2) of image B based on (ABA, image B, output o, (x2, y2)) among the mapping information. For convenience of explanation, the output location is denoted by coordinate values such as (x2, y2), but is not limited thereto. For example, the coordinate values may include values to represent areas such as (x2-x3, y2-y3).

The processor 130 may update the mapping information as the page of the screen changes. For example, when image A and image B are displayed on the first page of the screen, mapping information such as (AAA, image A, output o, (p1, x1, y1)), (ABA, image B, output o, (p1, x2, y2)), and (CCC, image C, output x, (, , )) may be stored in the memory 120. Subsequently, when the screen changes to the second page according to the user's manipulation and image C is displayed, the processor 130 may update the mapping information such as (AAA, image A, output o, (p1, x1, y1)), (ABA, image B, output o, (p1, x2, y2)), and (CCC, image C, output x, (p2, x3, y3)). Here, when a user voice such as “Run AAA of the previous page” is received, the processor 130 may identify the location of image Abased on the previous page and AAA.

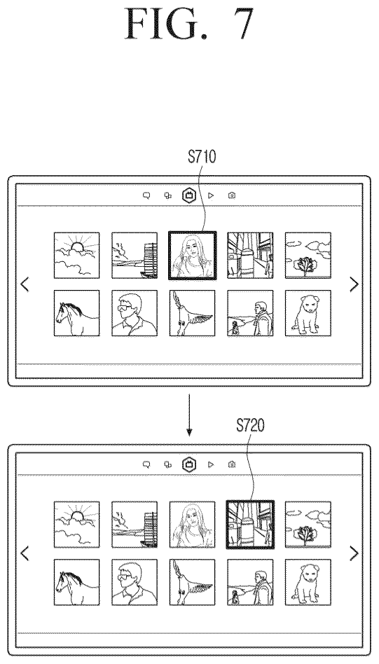

FIG. 7 is a view provided to explain an operation of identifying a location of a focus according to an embodiment.

When the executed application is capable of processing a touch input, the processor 130 may generate a virtual touch event at the poster location, and when the executed application is not capable of processing a touch input, the processor 130 may generate a remote control key sequence. In order to generate the remote control key sequence, it is necessary to first identify the current location of the focus.

For example, as shown in FIG. 7, the processor 130 may move the focus in the first location (S710), and identify the current location of the focus by comparing the captured image and another captured image corresponding to the screen including the focus (S720).

However, the present disclosure is not limited thereto, and the method of moving the location of the focus may vary. The processor 130 may also identify the location of the focus through image analysis without moving the location of the focus.

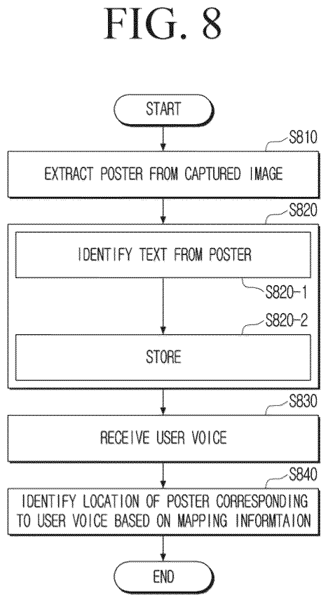

FIG. 8 is a view provided to explain an operation of identifying information about a poster in advance before a user voice is received according to an embodiment.

The processor 130 may extract a poster from a captured image (S810). For example, the processor 130 may extract a poster from a captured image of the screen currently being displayed, even before a user voice is received, based on at least one of hardware performance or resource status of the electronic apparatus 100. For example, the processor 130 may identify the location of each poster in the captured image.

The processor 130 may identify a text in the poster (S820-1), map the text to the poster and obtain it as mapping information, and store the obtained information in the memory 120 (S820-2).

When a user voice is received (S830), the processor 130 may identify the location of the poster corresponding to the user voice based on the mapping information (S840).

As described in FIGS. 5 and 6, compared to the first embodiment in which the poster information of the screen currently being displayed is obtained after the user voice is received, in the case of the second embodiment in which the poster information of the screen currently being displayed is obtained in advance before the user voice is received, as shown in FIG. 8, the operation of comparing the poster included in the mapping information with the captured image may be omitted, thereby reducing the processing time after the user voice is received.

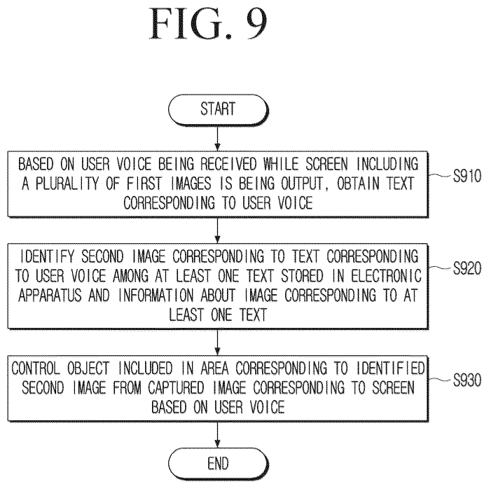

FIG. 9 is a flowchart provided to explain a controlling method of an electronic apparatus according to an embodiment.

First, when a user voice is received while a screen including a plurality of first images is being output, a text corresponding to the user voice is obtained (S910). A second image corresponding to the obtained text is identified among information about at least one text and an image corresponding to the at least one text stored in the electronic apparatus (S920). Subsequently, an object included in an area corresponding to the identified second image in the captured image corresponding to the screen is controlled based on the user voice (S930).

The method may further include outputting a screen including a plurality of first images based on each of the plurality of second images received from the server, and obtaining information about each of a plurality of texts obtained from the plurality of second images and the second image corresponding to each of the plurality of texts.

The operation of obtaining information about each of the plurality of texts and the second image corresponding to each of the plurality of texts may include obtaining each of the plurality of second images whose resolution is changed based on a resolution of each of the plurality of first images as information about the second image corresponding to each of the plurality of texts.

Further, the operation of obtaining information about each of the plurality of texts and the second image corresponding to each of the plurality of texts may include obtaining each of the plurality of second images in which a compressed resolution is adjusted based on an encoder included in the electronic apparatus as information about the second image corresponding to each of the plurality of texts.

The operation of obtaining information about each of the plurality of texts and the second image corresponding to each of the plurality of texts may include identifying a text corresponding to each of the plurality of second images among the plurality of texts from each of the plurality of second images and at least one candidate text, and obtaining information about the at least one candidate text and the second image corresponding to each of the plurality of texts.

The method may further include outputting the screen received from the server and obtaining information about at least one text obtained from the captured image and a first image corresponding to each of the at least one text.

The controlling operation S930 may include controlling an object based on a command input method supported by the application corresponding to the screen.

Further, the controlling operation S930 may include, when the command input method includes a touch input method, controlling an object based on a command to touch a point in an area corresponding to the identified second image.

The controlling operation S930 may include, when the command input method does not include a touch input method, controlling an object based on at least one first command for moving a focus included in the captured image to an area corresponding to the identified second image and a second command for executing the object after the first command.

Further, the operation of identifying a focus may include moving the focus and comparing the captured image and another captured image corresponding to the screen after the focus is moved to identify the current location of the focus.

According to one or more embodiments of the present disclosure, the electronic apparatus stores mapping information from the screen in advance and thus, the processing speed according to a user voice may be improved. Further, since the electronic apparatus obtains the mapping information based on the original images of the images included in the screen, the accuracy may be improved, so that the processing performance according to the user voice can be improved.

According to an embodiment, the above-described various embodiments may be implemented as software including instructions stored in machine-readable storage media, which can be read by machine (e.g., computer). The machine refers to a device that calls instructions stored in a storage medium, and can operate according to the called instructions, and the device may include an electronic device (e.g., electronic apparatus A) according to the aforementioned embodiments. In case an instruction is executed by a processor, the processor may perform a function corresponding to the instruction by itself, or by using other components under its control. The instruction may include a code that is generated or executed by a compiler or an interpreter. The machine-readable storage medium may be provided in the form of a non-transitory storage medium. Here, the term ‘non-transitory’ means that the storage medium is tangible without including a signal, and does not distinguish whether data are semi-permanently or temporarily stored in the storage medium.

In addition, according to an embodiment, the above-described methods according to the various embodiments may be included and provided in a computer program product. The computer program product may be traded as a product between a seller and a purchaser. The computer program product may be distributed in a form of a storage medium (e.g., a compact disc read only memory (CD-ROM)) that may be read by the machine or online through an application store (e.g., PlayStore™). In case of the online distribution, at least a portion of the computer program product may be at least temporarily stored in a storage medium such as a memory of a server of a manufacturer, a server of an application store, or a relay server or be temporarily generated.

In addition, according to an embodiment, the above-described various embodiments are may be implemented in a recording medium that can be read by a computer or a similar device using software, hardware, or a combination thereof. In some cases, embodiments described herein may be implemented by a processor itself. According to software implementation, embodiments such as procedures and functions described in this specification may be implemented as separate software modules. Each of the software modules may perform one or more functions and operations described in this disclosure.

Computer instructions for performing processing operations of devices according to the above-described various embodiments may be stored in a non-transitory computer-readable medium. When being executed by a processor of a specific device, the computer instructions stored in such a non-transitory computer-readable medium allows the specific device to perform processing operations in the device according to the above-described various embodiments. The non-transitory computer-readable medium refers to a medium that stores data semi-permanently and can be read by a device, rather than a medium that stores data for a short period of time, such as registers, caches, and memories. Specific examples of the non-transitory computer-readable medium may include CD, DVD, hard disk, Blu-ray disk, USB, memory card, ROM, etc.

In addition, the components (for example, modules or programs) according to various embodiments described above may include a single entity or a plurality of entities, and some of the corresponding sub-components described above may be omitted or other sub-components may be further included in the various embodiments. Alternatively or additionally, some components (e.g., modules or programs) may be integrated into one entity and perform the same or similar functions performed by each corresponding component prior to integration. Operations performed by the modules, the programs, or the other components according to the diverse embodiments may be executed in a sequential manner, a parallel manner, an iterative manner, or a heuristic manner, or at least some of the operations may be performed in a different order or be omitted, or other operations may be added.

Although embodiments of the present disclosure have been shown and described above, the disclosure is not limited to the specific embodiments described above, and various modifications may be made by one of ordinary skill in the art without departing from the spirit of the disclosure as claimed in the claims, and such modifications are not to be understood in isolation from the technical ideas or prospect of the disclosure.

What is claimed is:

1. An electronic apparatus comprising:
a microphone;
memory storing one or more instructions; and
one or more processors configured to individually or collectively execute the one or more instructions,
wherein one or more instructions, when individually or collectively executed by the one or more processors, cause the electronic apparatus to:
based on receiving a user voice through the microphone while a screen comprising a plurality of first images is being output, obtain text corresponding to the user voice;
identify a second image corresponding to the obtained text from among information about at least one text and an image corresponding to the at least one text, wherein the information about the at least one text and the image corresponding to the at least one text are stored in the memory; and
based on the user voice and a captured image of the screen, control an object in an area of the screen corresponding to the identified second image.

2. The electronic apparatus of claim 1, further comprising:
a communication interface; and
a display,
wherein the one or more instructions, when individually or collectively executed by the one or more processors, further cause the electronic apparatus to:
control the display to output the screen based on a plurality of second images received from a server through the communication interface; and
obtain information about each of a plurality of texts obtained from the plurality of second images and information about each second image, among the plurality of second images, corresponding to each of the plurality of texts.

3. The electronic apparatus of claim 2, wherein one or more instructions, when individually or collectively executed by the one or more processors, further cause the electronic apparatus to obtain, as the information about each second image corresponding to each of the plurality of texts, a version of each second image corresponding to each of the plurality of texts having a changed resolution.

4. The electronic apparatus of claim 3, wherein the one or more instructions, when individually or collectively executed by the one or more processors, further cause the electronic apparatus to obtain, a compressed version of each resolution adjusted second image as information about each second image corresponding to each of the plurality of texts.

5. The electronic apparatus of claim 2, wherein the one or more instructions, when individually or collectively executed by the one or more processors, further cause the electronic apparatus to:
identify one or more texts corresponding to each of the plurality of second images among the plurality of texts;
identify at least one candidate text among the one or more texts corresponding to each of the plurality of second images; and
obtain information about the one or more texts corresponding to each of the plurality of second images, the at least one candidate text, and each second image corresponding to each of the plurality of texts.

6. The electronic apparatus of claim 1, further comprising:
a communication interface; and
a display,
wherein the one or more instructions, when individually or collectively executed by the one or more processors, further cause the electronic apparatus to:
receive the screen from a server through the communication interface;
control the display to output the screen; and
obtain information about at least one text obtained from the captured image and at least one first image corresponding to each of the at least one text.

7. The electronic apparatus of claim 1, wherein the one or more instructions, when individually or collectively executed by the one or more processors, further cause the electronic apparatus to control the object based on a command input method supported by an application corresponding to the screen.

8. The electronic apparatus of claim 7, wherein the one or more instructions, when individually or collectively executed by the one or more processors, further cause the electronic apparatus to, based on the command input method comprising a touch input method, control the object based on a command corresponding to touching a point in an area corresponding to the identified second image.

9. The electronic apparatus of claim 7, wherein the one or more instructions, when individually or collectively executed by the one or more processors, further cause the electronic apparatus to, based on the command input method not comprising a touch input method, control the object based on at least one first command for moving a focus included in the captured image to an area corresponding to the identified second image and a second image for executing the object after the at least one first command.

10. The electronic apparatus of claim 9, wherein the one or more instructions, when individually or collectively executed by the one or more processors, further cause the electronic apparatus to:
move the focus; and
identify a current location of the focus by comparing the captured image and another captured image corresponding to a screen after the focus is moved.

11. A method of controlling an electronic apparatus, the method comprising:
based on receiving a user voice through a microphone of the electronic apparatus while a screen comprising a plurality of first images is being output, obtaining text corresponding to the user voice;
identifying a second image corresponding to the obtained text from among information about at least one text stored in the electronic apparatus and an image corresponding to the at least one text; and
controlling an object in an area of the screen corresponding to the identified second image based on a captured image of the screen and the user voice.

12. The method of claim 11, further comprising:
outputting the screen based on a plurality of second images received from a server; and
obtaining information about each of a plurality of texts obtained from the plurality of second images and information about each second image, among the plurality of second images, corresponding to each of the plurality of texts.

13. The method of claim 12, wherein the obtaining information about each of the plurality of texts and each second image, among the plurality of second images, corresponding to each of the plurality of texts comprises obtaining, as the information about each second image corresponding to each of the plurality of texts, a version of each second image corresponding to each of the plurality of texts having a changed resolution.

14. The method of claim 13, wherein the obtaining information about each of the plurality of texts and each second image corresponding to each of the plurality of texts further comprises obtaining a compressed version of each resolution adjusted second image as information about each second image corresponding to each of the plurality of texts.

15. The method of claim 12, wherein the obtaining information about each of the plurality of texts and each second image corresponding to each of the plurality of texts comprises:
identifying one or more texts corresponding to each of the plurality of second images among the plurality of texts;
identifying at least one candidate text among the one or more texts corresponding to each of the plurality of second images; and
obtaining information about the one or more texts corresponding to each of the plurality of second images, the at least one candidate text, and each second image corresponding to each of the plurality of texts.

16. A non-transitory computer readable medium having instructions stored therein, which when executed by at least one processor cause the at least one processor to execute a method of controlling an electronic apparatus, the method comprising:
based on receiving a user voice through a microphone of the electronic apparatus while a screen comprising a plurality of first images is being output, obtaining text corresponding to the user voice;
identifying a second image corresponding to the obtained text from among information about at least one text stored in the electronic apparatus and an image corresponding to the at least one text; and
controlling an object in an area of the screen corresponding to the identified second image based on a captured image of the screen and the user voice.

17. The non-transitory computer readable medium of claim 16, wherein the method further comprises:
outputting the screen based on a plurality of second images received from a server; and
obtaining information about each of a plurality of texts obtained from the plurality of second images and information about each second image, among the plurality of second images, corresponding to each of the plurality of texts.

18. The non-transitory computer readable medium of claim 17, wherein the obtaining information about each of the plurality of texts and each second image, among the plurality of second images, corresponding to each of the plurality of texts comprises obtaining, as the information about each second image corresponding to each of the plurality of texts, a version of each second image corresponding to each of the plurality of texts having a changed resolution.

19. The non-transitory computer readable medium of claim 18, wherein the obtaining information about each of the plurality of texts and each second image corresponding to each of the plurality of texts further comprises obtaining a compressed version of each resolution adjusted second image as information about each second image corresponding to each of the plurality of texts.

20. The non-transitory computer readable medium of claim 16, wherein the obtaining information about each of the plurality of texts and each second image corresponding to each of the plurality of texts comprises:
identifying one or more texts corresponding to each of the plurality of second images among the plurality of texts;
identifying at least one candidate text among the one or more texts corresponding to each of the plurality of second images; and
obtaining information about the one or more texts corresponding to each of the plurality of second images, the at least one candidate text, and each second image corresponding to each of the plurality of texts.
